(19) United States
(12) Patent Application Publication
(10) Pub. No.: US 2009/0207902 A1
(43) Pub. Date: Aug. 20, 2009

(54) Method and system for processing data

(76) Inventors: Wolfgang Niem, Hildesheim (DE); Ulrich-Lorenz Benzler, Langenhagen (DE)

Correspondence Address: KENYON & KENYON LLP, ONE BROADWAY, NEW YORK, NY, 10004, US

(21) Appl. No.: 11/918,768

(22) PCT Filed: Mar. 16, 2006
(86) PCT No.: PCT/EP2006/060778

§ 371 Date: Feb. 11, 2009

(30) Foreign Application Priority Data
Apr. 25, 2005 (DE) 10 2005 019 153.3

(51) Int. Cl. H04N 7/12; G06F 17/30

(52) U.S. Cl. 375/240.01; 707/200; 348/E07.085; 375/E07.076

(57) ABSTRACT

A method for processing data, including the recording of raw data, processing, particularly digitizing, compressing and/or encoding, the raw data, analysis, particularly performing a content analysis, of the raw data or the processed data, interpretation, particularly performing an event recognition, of the analysis results in order to generate a semantic description of the contents, indexing of the processed data with the aid of the semantic description, processing of the indexed data. A data-processing system having a recording device for recording raw data, at least one processing device for the processing, particularly digitizing, compressing and/or encoding, of the raw data; for interpreting the analysis results, particularly for performing an event recognition in order to generate a semantic description of the contents; and for processing the indexed data; an analyzer device for the analysis, particularly for performing a content analysis, of the raw data or the processed data, and an indexing device for indexing the processed data with the aid of the semantic description. This method and this system provide improved data processing, especially of audio data and/or video data.

### FIELD OF THE INVENTION

The present invention relates to a method for processing data, a data-processing system, a computer program and a computer-program product.

### BACKGROUND INFORMATION

In the following, reference is basically made to video archiving, without restricting the present invention to this application.

Conventional video-monitoring systems have connected archiving devices such as digital video recorders (DVR) or network video recorders (NVR) which provide distributed storage in the network. Large volumes of data result from the monitoring, which must be stored or archived. Therefore, strategies exist for reducing and erasing video data after stipulated periods of time, as well as for optimizing the physical storage space needed.

For example, in monitoring systems, the video data are encoded using different methods, e.g., MPEG-2, MPEG-4, typically the same video data being stored in different quality levels and/or resolution levels, spatially and temporally. During further treatment of the stored video data over time, generally the video having the highest quality is erased first, then, after a specific period of time, the video having average quality, and finally the video having the lowest quality. This is known as erosion storage or erosion-storage method.

Increased encoding and storage requirements exist due to the encoding of the video data in several different video-data streams having varied quality. Moreover, in the case of erosion-storage methods, the video data are reduced and erased in purely time-controlled fashion, and therefore completely arbitrarily.

### SUMMARY

In an example method of the present invention for processing data, raw data are recorded, for example, in a microphone, a video camera, etc.; the raw data are processed, especially digitized, compressed and/or encoded. Conventional encoding methods such as MPEG, MP3, JPEG, etc., may be used in particular. The raw data or the processed data are analyzed as well, in particular, a content analysis is performed. This step is also known as feature extraction. In the case of video data, for example, color recognition, brightness recognition, motion recognition, face recognition or person recognition are possibilities. In this case, the features “color”, “brightness”, “person”, “face”, “movement direction”, etc., are generated. Preferably the features are extracted automatically, for example, by pattern-recognition methods. The analysis results or features are subsequently interpreted, in particular an event recognition is performed in order to generate a semantic description of the contents, so-called metadata; in so doing, the individual features are considered in particular. For example, the description contains the combination of specific values such as brightness or color values, vectors or coordinates of a movement. Therefore, in the case of video data, for example, objects and their movements, events or the actions of persons are described. In the further course of the example method according to the present invention, the processed raw data are indexed with the aid of the semantic description, for which preferably so-called smart indexing methods such as MPEG-7 are used. In so doing, the video data are combined with the metadata, particularly in order to provide search and evaluation capability. Finally, the indexed data are processed. To that end, for example, they are transferred to a digital video recorder (DVR) or a network video recorder (NVR). In particular, conventional computers, embedded systems, integrated circuits or other computer units continue to be suitable for implementing all indicated method steps. The example method of the present invention advantageously allows data, together with an associated content description, to be made available for further processing, which means targeted, content-dependent, further processing steps become possible.

It may be particularly advantageous if, using an example method according to the present invention, a scalable encoding is carried out, especially according to an MPEG-2, MPEG-4 or MPEG-21 standard, during processing of the raw data. Given a scalable encoding, data content can easily be removed after the encoding in order to reduce the volume of data, for example, without having to carry out a reencoding process. So, for example, in the case of video data, data may be erased—with loss of quality—from a video data stream scalably encoded one time, the video data stream continuing to remain decodable, thus observable for the user. The following modes present themselves to be used alone or in combination. An “SNR scalability” is achieved by the encoding of each image in several layers. If only the lowest layer is decoded, a poor image quality results. The quality is increased stepwise by additional decoding of the superjacent layers. In the case of a temporal scalability, several images are encoded per unit of time in the lowest layer and additional images are encoded per unit of time in the higher layers. In the case of a spatial scalability, one image is encoded with different pixel resolutions. The data partitioning permits a scalability with respect to fault resistance. In the example embodiment, the most important components of the data stream are transmitted in the lowest layer, less important parts in the higher layers.

In an embodiment of the method according to the present invention, during the processing of the indexed data, the volume of indexed data is reduced. The storage space required is thereby advantageously reduced.

To that end, for example, in the case of scalably encoded video data, the local or temporal resolution, color information or audio information may be—especially partially —reduced.

In the example method of the present invention, it is particularly expedient if, upon processing of the indexed data, the indexed data are stored in a storage device. Thus, it is possible to retain the recorded and processed raw data permanently or for a predetermined period of time.

In the example method of the present invention, it is particularly preferred if, upon processing of the indexed data, the indexed data are evaluated. By indexing the data, a content description has resulted which advantageously may be used for an evaluation. The evaluation should be a function of the purpose for which the data were recorded. So, for example, video scenes having high motion content could be evaluated higher than scenes having low motion content. If faces or persons have been detected, for instance, these video data are evaluated higher than scenes in which no persons are present. For example, if video monitoring is involved, where different events have been detected and indexed, an evaluation may be carried out on the basis of these events.

Moreover, it may be expedient if, using the example method of the present invention, the indexed data are stored in a storage device as a function of the evaluation, the storage device including storage areas having different failure safety, particularly RAID arrays, higher-evaluated data being stored in storage areas having higher failure safety. In the case of RAID arrays, different levels of failure safety are generally known. The levels 0, 1, 2, 3, 4, 5, 6, 7, 10, 50 can be named here by way of example; it must be kept in mind that the quality or the functionality of the corresponding RAID system cannot be inferred directly from the numerical value of a level. The significance of the respective levels is familiar to one skilled in the art. In the evaluation, advantageously a so-called event list is generated with the aid of stipulated storage rules. For example, storing high-evaluated data in a RAID-1 system and low-evaluated data in a RAID-0 system would provide a solution.

One example embodiment of the method according to the present invention, in which the storage device is in the form of a RAID array and the storage areas having different failure safety are formed within this RAID array, is particularly preferred. In this context, storage areas having different failure safety or different redundancy levels may advantageously be provided within a RAID array. The different redundancy levels are achieved in particular by suitable data processing, such as Reed-Solomon codes, for example.

Especially in combination with a scalable encoding, advantageous effects may therefore be achieved with respect to the storage requirements and the failure safety in the case of both embodiments indicated above. Given a scalable encoding, in particular the contents may be organized specific to quality without a costly reencoding being necessary. This may be accomplished by selective sorting. For example, scenes or scene segments having high evaluation may be stored in storage areas having high failure safety, while scenes or scene segments from the same video data streams having low evaluation are stored in storage areas having lower failure safety. Moreover, the use of RAID systems and/or RAID arrays offers the advantage of being able to use customary and therefore inexpensive hard disks.

Advantageously, in the example method of the present invention, the volume of indexed data is reduced as a function of the evaluation, the volume of higher-evaluated data in particular being reduced less sharply. In the case of video data, for instance, this is known as erosion. In the evaluation, advantageously a so-called temporal event list is generated with the aid of stipulated temporal erosion rules. It should be noted that this temporal event list can differ from the event list dealt with above in the context of the storage strategy, but does not have to. The volumes of data and, associated with that, the quality of the indexed video data are reduced with the aid of this temporal event list. Especially in combination with a scalable encoding, it is again possible to achieve advantageous effects with respect to storage requirements and long-term retention. Given a scalable encoding, in particular the contents may be organized specific to quality without a costly reencoding being necessary. This may be achieved by selective erasure of data portions no longer needed. For example, scenes or scene segments having high evaluation may be retained in better quality—i.e., higher spatial, temporal, color-related, etc., resolution—than scenes or scene segments from the same video data streams having low evaluation.

In one preferred exemplary embodiment of the method according to the present invention, the stored data are processed at least one further time. In the case of video monitoring, for instance, it presents itself to evaluate the stored data anew at regular intervals, reduce it appropriately and store it distributed to areas having different failure safety. The storage space needed may thereby advantageously be further reduced, important information, that is, information which was more highly evaluated, being available in better quality and over a longer period of time than less important information.

In the example method of the present invention, it may be expedient to use parameters from the group including audio-, infrared- & radar signals when interpreting the analysis results, particularly when performing an event recognition. It presents itself to use data from motion detectors, infrared or heat sensors, ultrasonic sensors, etc., which likewise provide indices for motion, persons, etc. In this manner, it is possible to advantageously improve an event recognition.

The example method of the present invention may be used particularly advantageously when the raw data are video and/or audio data. Naturally, in addition to that, processing of other data containing information, such as texts, images, etc., is also useful.

An example data-processing system according to the present invention has a recording device for recording raw data, e.g., a video camera, and at least one processing device for processing, especially digitizing, compressing and/or encoding, the raw data; for interpreting the analysis results, especially for performing an event recognition, in order to generate a semantic description of the contents; and for processing the indexed data. The individual processing steps may also be carried out by different processing devices, for which, for instance, the indicated DVR and NVR, a conventional computer, an embedded system, an integrated circuit or other computer unit are suitable. Furthermore, the data-processing system has an indexing device for indexing the processed data with the aid of the semantic description. It goes without saying as well that the recording device combined, for instance, with a processing device for digitizing, compressing and/or encoding, may be designed as a digital video camera or the like, or that all the indicated units may be realized together or in other combinations in a DVR or NVR, without departing from the scope of the present invention.

In one preferred refinement of the system according to the present invention, at least one processing device has an evaluation device, storage device, reducing device and/or a storage device, such as RAID systems or NAS systems.

For further clarification of the functioning method and of the advantages of the example device according to the present invention and of the example system, reference is made explicitly to the explanations with respect to the example method of the present invention.

An example computer program of the present invention includes program-code means, in order to implement the method of the present invention when the computer program is executed on a computer or a suitable computer unit, especially a data-processing device according to the present invention or a data-processing system according to the present invention.

An example computer-program product according to the present invention contains program-code means that are stored on a computer-readable data carrier, in order to implement a method of the present invention when the computer-program product is executed on a computer or on a suitable computer unit, especially a data-processing device according to the present invention or a data-processing system according to the present invention. Suitable data carriers are, in particular, diskettes, hard disks, flash memories, EEPROMs, CD-ROMS, and other similar carriers. A download of a program via computer networks (Internet, intranet, etc.) is also possible

Further advantages and refinements of the present invention are yielded from the description below and the accompanying figures.

It is understood that the aforementioned features and the features yet to be explained below may be used not only in the combination indicated in each instance, but also in other combinations or by themselves, without departing from the scope of the present invention.

The present invention is represented schematically in the figures based on an exemplary embodiment and is described in detail below with reference to the figures.

### BRIEF DESCRIPTION OF THE DRAWINGS

FIG. 1 shows a schematic representation of a preferred specific embodiment of a system according to the present invention.

FIG. 2 shows a flow chart of an example method according to the present invention.

### DETAILED DESCRIPTION OF EXAMPLE EMBODIMENTS

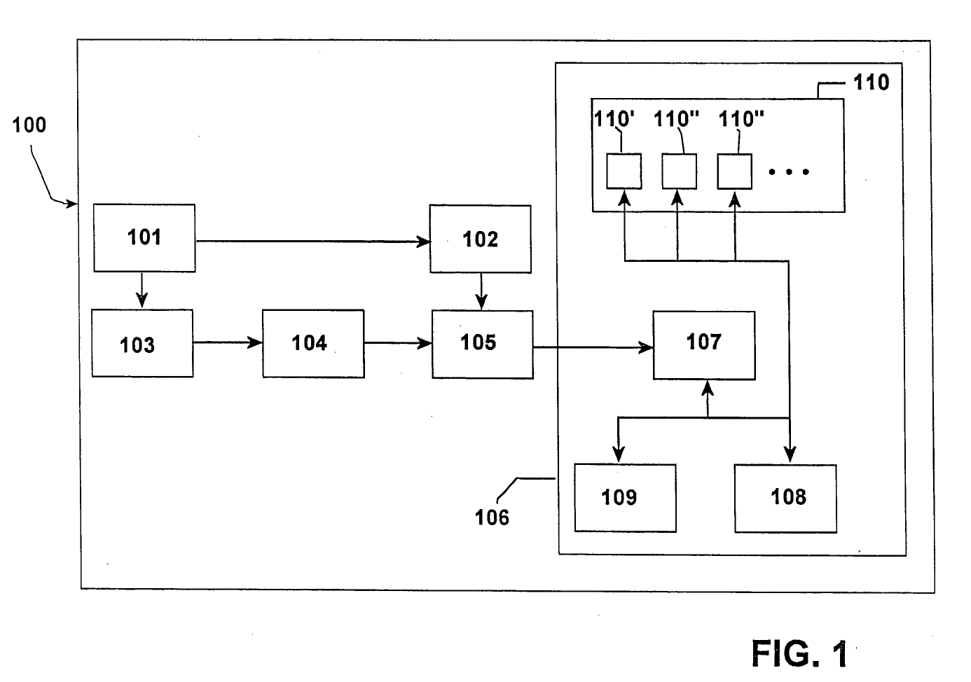

In FIG. 1, a preferred exemplary embodiment of a data-processing system according to the present invention is designated as a whole by 100. Data-processing system 100 is designed as a video monitoring system and has a recording device 101 for recording raw data, which, in the case of video data, is preferably in the form of a video camera. The raw data are transmitted from video camera 101 to a processing device 102 and an analyzer device 103.

Processing device 102 is designed for encoding the raw data. In the preferred specific embodiment depicted, processing device 102 encodes the raw data in scalable fashion, particularly according to the MPEG-4 standard, which means it is easily possible to alter or remove data contents after the encoding in order to reduce the data volume, for example, without having to carry out a reencoding process.

Analyzer device 103 performs a content analysis. In so doing, individual features of the video data are extracted, color, brightness, motion, facial or personal features being used in particular. Automatic methods of pattern recognition are used for the feature extraction. Other methods may be used as well.

The features extracted by analyzer device 103 are transferred to a processing device 104. Processing device 104 performs an event recognition in order to generate a semantic description of the contents of the video data, so-called metadata. The description is generated by interpreting the individual features as they were transferred by analyzer device 103. Processing device 104 generates a description of the projects and their movements, of events and of the actions of persons.

The metadata generated by processing device 104, together with the video data encoded by processing device 102, are provided to an indexing device 105. Indexing device 105 indexes the encoded video data with the aid of the semantic description, for which a “smart indexing” method such as MPEG-7 is used. Search and evaluation capability are provided by the indexing of the video data with the aid of the metadata.

Finally, the indexed data are transferred to a processing device 106. In the exemplary embodiment shown, processing device 106 is in the form of a digital video recorder (DVR).

DVR 106 has a storage device 110, which makes available storage areas having different failure safety 110′, 110″, 110″′, etc. Storage device 110 is in the form of a RAID array that has storage areas 110′, 110″, 110″′, etc., having different redundancy levels. Storage area 110′ of RAID array 110 has the highest failure safety or redundancy, storage area 110″ has an average, and storage area 110″′ has a low failure safety or redundancy. In this example, the levels of redundancy are achieved by using a Reed-Solomon code.

Moreover, DVR 106 is equipped with an evaluation device 107, storage device 108 and reducing device 109 which access evaluation device 107. According to the present invention, a DVR or NVR may likewise be designed as a device or system that may be furnished with other or all units (101 through 110).

Storage device 108, together with evaluation device 107, generates a so-called event list with the aid of predetermined storage rules. In the event list, the scenes and/or scene segments of the video data are listed in order of their evaluation. Storage device 108 stores the scenes and/or scene segments of the video data corresponding to their evaluation in storage areas 110′, 110″, 110″′, etc., of RAID array 110. Thus, the scenes and scene segments having the highest evaluation are stored in storage area 110′ having the highest failure safety, etc.

Reducing device 109 reduces the volume of video data as a function of an evaluation which was generated by evaluation means 107. In so doing, reducing device 109 generates a so-called temporal event list with the aid of stipulated temporal erosion rules. The volume of video data is reduced based on the temporal event list. Because scalable encoding has been implemented, reducing device 109 is able to reduce the video data without a costly reencoding being necessary. Thus, portions of the video data no longer needed may be erased selectively at predetermined time intervals based on the temporal event list. In so doing, scenes or scene segments having high evaluation are retained in better quality (high spatial, temporal, color, etc. resolutions) than scenes or scene segments from the same video data having lower evaluation; that is to say, the scenes or scene segments having lower evaluation are more sharply reduced.

Evaluation device 107 of DVR 106 evaluates the indexed data based on their content description. In so doing, the evaluation is carried out as a function of the purpose for which the data was recorded. If video data of a monitoring device are involved, video scenes having high motion content are evaluated higher than scenes having low motion content. In the same way, scenes having detected faces or persons are evaluated higher than scenes in which no persons are present.

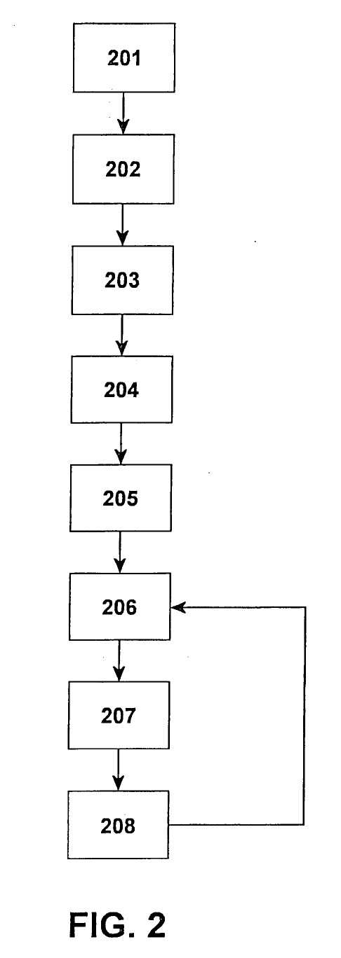

FIG. 2 shows an exemplary embodiment of a method according to the present invention. In step 201, the raw data are recorded. In particular, a video camera may be used for that purpose. In step 202, the recorded data are processed, i.e., digitized, compressed and/or encoded, a scalable encoding being used. This step could also be carried out completely or partially in the video camera.

In step 203, the contents of the video data are analyzed. In so doing, as explained above, the individual features are extracted. In step 204, an event recognition is performed on the basis of the extracted features, a semantic description of the contents being generated.

In step 205, the encoded data are merged with the semantic description or the metadata, and in this way indexed.

In method step 206, the indexed data are evaluated. The evaluation is carried out in the manner already described in detail. In method step 207, the indexed data are reduced on the basis of the evaluation, and finally in step 208, are stored on the basis of the same or a further evaluation.

Depending on the application purpose of the method, method steps 206 through 208 are performed again after a predetermined period of time; in the case of video monitoring, the stored data are evaluated anew at regular intervals, reduced appropriately and stored, that is, distributed to areas having different failure safety. Therefore, the storage space necessary for the video monitoring is advantageously reduced, important information, that is, information provided with high evaluation being available in better quality and over a longer period of time than less important information.

1-15. (canceled)

16. A method for processing data, comprising:
recording raw data;
processing the raw data to form processed data;
performing a content analysis of the content of one of the raw data or the processed data;
performing an event recognition of results of the analysis to generate a semantic description of the content;
indexing the processed data using the semantic description; and
processing the indexed data.

17. The method according to claim 16, wherein the processing of the raw data includes at least one of digitizing, compressing, and encoding.

18. The method as recited in claim 16, wherein during processing of the raw data, a scalable encoding is carried out, according to one of an MPEG, MPEG-2, MPEG-4 or MPEG-21 standard.

19. The method as recited in claim 16, wherein during processing of the indexed data, a volume of the indexed data is reduced.

20. The method as recited in claim 16, wherein during processing of the indexed data, the indexed data are stored in a storage device.

21. The method as recited in claim 16, wherein during processing of the indexed data, the indexed data are evaluated.

22. The method as recited in claim 21, wherein the indexed data are stored in a storage device as a function of the evaluation, the storage device including storage areas having different failure safety, higher-evaluated data being stored in storage areas having higher failure safety.

23. The method as recited in claim 22, wherein the storage device is in the form of a RAID array, and the storage areas having different failure safety are formed within the RAID array.

24. The method as recited in claim 21, wherein a volume of the indexed data is reduced as a function of the evaluation, a volume of higher-evaluated data being reduced less.

25. The method as recited in claim 20, wherein the stored data are processed at least one further time.

26. The method as recited in claim 17, wherein parameters from a group including at least one audio-, infrared- and radar signals are used when performing the event recognition.

27. The method as recited in claim 17, wherein the raw data are at least one of video data and audio data.

28. A data-processing system, comprising:
a recording device adapted to record raw data;
at least one processing device adapted to process the raw data, perform an event recognition to generate a semantic description of the contents, and process the indexed data;
an analyzer device adapted to perform a content analysis of one of the raw data or the processed data; and
an indexing device adapted to index the processed data using the semantic description.

29. The data processing system as recited in claim 28, wherein the at least one processing device is adapted to provide the raw data by at least one of digitizing, compressing and encoding.

30. The data-processing apparatus as recited in claim 28, wherein the at least one processing device includes at least one of an evaluation device, a storage device, and a reducing device.

31. An electronic medium storing a computer program, when executed by a computer, the computer program causing the computer to perform the steps of:
recording raw data;
processing the raw data to form processed data;
performing a content analysis of the content of one of the raw data or the processed data;
performing an event recognition of results of the analysis to generate a semantic description of the content;
indexing the processed data using the semantic description; and
processing the indexed data.

32. A computer-readable data carrier, storing a computer program, when executed by a computer, the computer program causing the computer to perform steps:
recording raw data;
processing the raw data to form processed data;
performing a content analysis of the content of one of the raw data or the processed data;
performing an event recognition of results of the analysis to generate a semantic description of the content;
indexing the processed data using the semantic description; and
processing the indexed data.
